(19) United States
(12) Patent Application Publication
(10) Pub. No.: US 2018/0166749 A1
(43) Pub. Date: Jun. 14, 2018

(54) ION-TRAPPING AGENT, ELECTROLYTE SOLUTION, AND SEPARATOR FOR LITHIUM-ION RECHARGEABLE BATTERY, AND LITHIUM-ION RECHARGEABLE BATTERY

(71) Applicant: TOAGOSEI CO., LTD., Tokyo (JP)

(72) Inventors: Yasuharu ONO, Nagoya-shi, Aichi (JP); Satoko ANDO, Nagoya-shi, Aichi (JP)

(73) Assignee: TOAGOSEI CO., LTD., Tokyo (JP)

(21) Appl. No.: 15/578,479

(22) PCT Filed: Jun. 2, 2016
(86) PCT No.: PCT/JP2016/066335

§ 371 Date: Nov. 30, 2017

(30) Foreign Application Priority Data
Jun. 4, 2015 (JP) 2015-114246

(51) Int. Cl. H01M 10/42; H01M 2/16; H01M 4/62; H01M 10/0525; H01M 10/0567; C01B 25/37; C01B 25/36

(52) U.S. Cl. CPC H01M 10/4235; H01M 2/1646; H01M 4/628; C01B 25/36; H01M 10/0567; C01B 25/372; H01M 10/0525

(57) ABSTRACT

The invention provides an ion-trapping agent for a lithium-ion rechargeable battery, which traps impurity metal ions generated from constituent parts of a lithium-ion rechargeable battery with high selectivity, has high adsorption capacity per unit mass, suppresses the occurrence of short circuit derived from impurities, and renders a liquid neutral such that the lithium-ion rechargeable battery is unlikely to influence an electrolyte solution, thereby imparting a long-life lithium-ion rechargeable battery. The ion-trapping agent for a lithium-ion rechargeable battery of the invention contains at least one phosphate selected from: (A) α-zirconium phosphate having a specific composition in which a certain range of ion exchange groups are substituted by lithium ions; (B) α-titanium phosphate having a specific composition in which a certain range of ion exchange groups are substituted by lithium ions; or (C) aluminium dihydrogen triphosphate having a specific composition in which a certain range of ion exchange groups are substituted by lithium ions.

### TECHNICAL FIELD

The present invention relates to an ion-trapping agent, an electrolyte solution, and a separator which are preferable constituent elements of a lithium-ion rechargeable battery, and a lithium-ion rechargeable battery containing the same.

### BACKGROUND ART

Lithium-ion rechargeable batteries are lightweight and have high input-output characteristics, compared with other rechargeable batteries such as nickel-hydrogen batteries and lead storage battery. Therefore, the lithium-ion rechargeable batteries have been gaining attention as high-output power sources used for electric vehicles, hybrid electric vehicles, and the like.

However, in a case in which impurities (e.g., magnetic impurities including iron, nickel, manganese, copper, and the like or their ions) are present in parts that constitute a lithium-ion rechargeable battery, the lithium metal is deposited on the negative electrode during charging and discharging. Then, lithium dendrite deposited on the negative electrode breaks the separator and reaches the positive electrode, which may cause short circuit.

Further, since lithium-ion rechargeable batteries are used in various places, there is a case in which the temperature inside a vehicle or the like reaches, for example, from 40° C. to 80° C. In such case, a metal such as manganese is eluted from a lithium-containing metal oxide as a constituent material of a positive electrode and deposited on a negative electrode, which may reduce battery characteristics (i.e., capacity).

In response to such problem, for example, Patent Document 1 discloses a lithium-ion rechargeable battery including a trapping substance that functions to trap impurities or by-products generated inside the lithium-ion rechargeable battery via absorption or adsorption. Patent Document 1 describes trapping substances such as activated carbon, silica gel, and zeolite.

Further, Patent Document 2 discloses a nonaqueous lithium-ion rechargeable battery, in which a positive electrode containing a positive electrode active material that is a lithium compound containing a metal element such as Fe or Mn as a constituent element and a negative electrode containing a negative electrode active material that is a carbon material capable of absorbing and desorbing lithium ions are disposed separately in a nonaqueous electrolyte solution, the positive electrode containing zeolite at from 0.5 to 5% by weight with respect to the positive electrode active material, and the zeolite having an effective pore size of 0.5 nm (5 Å) or less, which is greater than the ion radius of the metal element.

Further, Patent Documents 3 to 5 each disclose aluminum silicate having a specific composition and a specific structure, and a lithium-ion rechargeable battery and members thereof using the same.

### PRIOR ART REFERENCES

### Patent Documents

Patent Document 1: Japanese Patent Application Laid-Open (JP-A) No. 2000-77103

Patent Document 2: Japanese Patent Application Laid-Open (JP-A) No. 2010-129430

Patent Document 3: WO 2012/124222

Patent Document 4: Japanese Patent Application Laid-Open (JP-A) No. 2013-127955

Patent Document 5: Japanese Patent Application Laid-Open (JP-A) No. 2013-127955

### SUMMARY OF INVENTION

### Problems to be Solved by the Invention

However, ion adsorbents disclosed in the patent documents described above are unable to trap impurities with high selectivity in some cases. In addition, as adsorption capacity per unit mass is insufficient, required life characteristics cannot be obtained in some cases. Further, even in the case of sufficient ion adsorption capacity, as an ion-trapping agent exhibits alkalinity, an electrolyte solution is decomposed, causing an increase in resistance, which has been problematic.

An object of the invention is to provide an ion-trapping agent for a lithium-ion rechargeable battery, which traps impurity metal ions generated from constituent parts of a lithium-ion rechargeable battery with high selectivity and has high adsorption capacity per unit mass, and a lithium-ion rechargeable battery including the ion-trapping agent, which is excellent in terms of cycle characteristics and safety. Another object of the invention is to provide an ion-trapping agent for a lithium-ion rechargeable battery, which exhibits neutrality and has a small impact on an electrolyte solution. Yet another object of the invention is to provide an electrolyte solution and a separator, which suppresses the occurrence of short circuit derived from impurities and an increase in resistance, thereby imparting a long-life lithium-ion rechargeable battery.

### Means for Solving the Problems

The inventors found that an ion-trapping agent containing a phosphate, in which at least some of ion exchange groups are substituted by lithium ions, traps Ni²⁺ ions and Mn²⁺ ions with high selectivity and has high adsorption capacity per unit mass. The inventors also found that a lithium-ion rechargeable battery provided with a separator containing the ion-trapping agent is excellent in terms of cycle characteristics and safety.

Specifically, the invention is described as follows.

<1> An ion-trapping agent for a lithium-ion rechargeable battery, which contains a phosphate in which some of ion exchange groups are substituted by lithium ions.
<2> The ion-trapping agent for a lithium-ion rechargeable battery according to <1> described above, wherein the phosphate is at least one selected from:

(A) α-zirconium phosphate in which at least some of ion exchange groups are substituted by lithium ions;

(B) α-titanium phosphate in which at least some of ion exchange groups are substituted by lithium ions; or

(C) aluminium dihydrogen triphosphate in which at least some of ion exchange groups are substituted by lithium ions.

<3> The ion-trapping agent for a lithium-ion rechargeable battery according to <2> described above, wherein the component (A) is α-zirconium phosphate in which ion exchange groups accounting for from 0.1 to 6.7 meq/g out of the total cation exchange capacity are substituted by the lithium ions.
<4> The ion-trapping agent for a lithium-ion rechargeable battery according to <2> or <3> described above, wherein α-zirconium phosphate before substitution by the lithium ions is a compound represented by the following Formula (1):

Zr₁₋ₓHfₓHₐ(PO₄)_{b}.nH₂O (1)

(where a and b are positive numbers satisfying 3b−a=4, 2<b≤2.1, 0≤x≤0.2, and 0≤n≤2).
<5> The ion-trapping agent for a lithium-ion rechargeable battery according to <2> described above, wherein the component (B) is α-titanium phosphate in which ion exchange groups accounting for from 0.1 to 7.0 meq/g out of the total cation exchange capacity are substituted by the lithium ions.
<6> The ion-trapping agent for a lithium-ion rechargeable battery according to <2> or
<5> described above, wherein α-titanium phosphate before substitution by the lithium ions is a compound represented by the following Formula (2):

TiHₛ(PO₄)ₜ.nH₂O (2)

(where s and t are positive numbers satisfying 3t−s=4, 2<t≤2.1, and 0≤n≤2).
<7> The ion-trapping agent for a lithium-ion rechargeable battery according to <2>described above, wherein the component (C) is aluminium dihydrogen triphosphate in which ion exchange groups accounting for from 0.1 to 6.9 meq/g out of the total cation exchange capacity are substituted by the lithium ions.
<8> The ion-trapping agent for a lithium-ion rechargeable battery according to <2> or <7> described above, wherein aluminium dihydrogen triphosphate before substitution by the lithium ions is a compound represented by the following Formula (3):

AlH₂P₃O₁₀.nH₂O (3)

(where n is a positive number).
<9> The ion-trapping agent for a lithium-ion rechargeable battery according to any one of <1> to <8> described above, wherein the water content is 10% by mass or less.
<10> An electrolyte solution, which contains the ion-trapping agent for a lithium-ion rechargeable battery according to any one of <1> to <9> described above.
<11> A separator, which contains the ion-trapping agent for a lithium-ion rechargeable battery according to any one of <1> to <9> described above.
<12> A lithium-ion rechargeable battery, which includes a positive electrode, a negative electrode, an electrolyte solution, and a separator, wherein at least one of the positive electrode, the negative electrode, the electrolyte solution, or the separator contains the ion-trapping agent for a lithium-ion rechargeable battery according to any one of <1> to <9> described above.

### Effect of the Invention

The ion-trapping agent for a lithium-ion rechargeable battery of the invention traps impurity metal ions generated from constituent parts of a lithium-ion rechargeable battery with high selectivity, and has high adsorption capacity per unit mass. Therefore, it is possible to suppress the occurrence of short circuit caused by impurities in a lithium-ion rechargeable battery, in which the ion-trapping agent is contained in an electrolyte solution or a member that is brought into contact with an electrolyte solution, such as a separator. In addition, as the ion-trapping agent for a lithium-ion rechargeable battery of the invention renders a liquid neutral, even in a case in which an electrolyte solution is prepared using the ion-trapping agent, the ion-trapping agent is unlikely to influence the electrolyte solution, thereby making it possible to impart a long-life lithium-ion rechargeable battery.

The lithium-ion rechargeable battery of the invention is excellent in cycle characteristics during charging and discharging and safety when receiving an impact.

### BRIEF DESCRIPTION OF DRAWINGS

FIG. 1 is a schematic diagram illustrating an example of a leaded electricity storage element that constitutes the lithium-ion rechargeable battery of the present invention.

FIG. 2 is a schematic view illustrating a cross-sectional structure of a separator in an embodiment (S1).

FIG. 3 is a schematic view illustrating a cross-sectional structure of a separator in an embodiment (S2).

FIG. 4 is a schematic view illustrating a cross-sectional structure of a separator in an embodiment (S3).

FIG. 5 is a schematic view illustrating a cross-sectional structure of a separator in an embodiment (S4).

### DESCRIPTION OF EMBODIMENTS

The invention is described in detail below.

The ion-trapping agent for a lithium-ion rechargeable battery of the invention (hereinafter sometimes simply referred to as the “ion-trapping agent”) is characterized by containing a phosphate in which at least some of ion exchange groups are substituted by lithium ions (hereinafter referred to as a “lithium ion-containing phosphate”). The ion-trapping agent of the invention may consist of a lithium ion-containing phosphate or may be formed with a lithium ion-containing phosphate and different compounds.

The ion-trapping agent of the invention has excellent ability to trap unnecessary metal ions such as manganese ions (Mn²⁺), nickel ions (Ni²⁺), copper ions (Cu²⁺), and iron ions (Fe²⁺) in a lithium-ion rechargeable battery while having poor ability to trap lithium ions. Therefore, the ion-trapping agent can effectively trap the metal ions, which may cause short circuit. The metal ions are derived from impurities present in the constituent members of a lithium-ion rechargeable battery or metals eluted from the positive electrode at high temperatures.

In addition, any phosphate, in which ion-exchange groups are yet to be substituted by lithium ions, is in the form of a layered compound having layers rich in OH groups. A lithium ion-containing phosphate, on which lithium ions are supported, is also a layered compound. By allowing, for example, an electrolyte solution or a separator to include such ion-trapping agent containing a lithium ion-containing phosphate, it is possible to selectively trap manganese ions, nickel ions, or the like without trapping lithium ions in the electrolyte solution.

Further, as the ion-trapping agent of the invention renders a liquid neutral, even in a case in which it is added to an electrolyte solution, the pH of the electrolyte solution does not vary significantly. Specifically, when an electrolyte solution contains an alkaline substance, the electrolyte solution is decomposed as pH increases, thereby facilitating generation of lithium carbonate, which disadvantageously causes an increase in resistance. However, the ion-trapping agent of the invention does not cause such disadvantageous problem. Moreover, since the ion-trapping agent of the invention is an inorganic substance, it has excellent thermal stability and excellent stability in an organic solvent. Therefore, in a case in which the ion-trapping agent is contained a constituent member of a lithium-ion rechargeable battery, it can be stably present even during charging and discharging.

The lithium ion-containing phosphate is described below.

(A) α-zirconium phosphate in which at least some of ion exchange groups are substituted by lithium-ions
(B) α-titanium phosphate in which at least some of ion exchange groups are substituted by lithium-ions
(C) aluminium dihydrogen triphosphate in which at least some of ion exchange groups are substituted by lithium-ions

The ion-trapping agent of the invention may contain these phosphates, which are used singly, or in combination of two or more kinds thereof.

The component (A) is a lithium ion substitute of α-zirconium phosphate.

Ion exchange groups of the α-zirconium phosphate (unsubstituted α-zirconium phosphate) are usually protons. Some or all of the protons are substituted by lithium ions such that the component (A) is formed.

The above-described α-zirconium phosphate is preferably a compound represented by the following Formula (1):

Zr₁₋ₓHfₓHₐ(PO₄)_{b}.nH₂O (1)

(where 0≤x≤0.2, 2<b≤2.1, a is a number satisfying 3b−a=4, and 0≤n≤2).

The amount of lithium ions as substituents in the compound of Formula (1) is preferably from 0.1 to 6.7 meq/g and more preferably from 1.0 to 6.7 meq/g. In view of ability to trap ions such as Mn²⁺ ions and Ni²⁺ ions, the amount of lithium ions is particularly preferably from 2.0 to 6.7 meq/g.

In Formula (1), x is preferably 0≤x≤0.1 and more preferably 0≤x≤0.02 from the viewpoint of ability to trap ions such as Mn²⁺ ions and Ni²⁺ ions. In addition, in a case in which Hf is contained, x is preferably 0.005≤x≤0.1 and more preferably 0.005≤x≤0.02. In the case of x>0.2, ion exchange performance with lithium ions is improved. However, the presence of radioactive isotopes may adversely affect electronic components in a case in which constituent parts of a lithium-ion rechargeable battery include electronic parts.

A method of producing the component (A) is not particularly limited. For example, a method in which α-zirconium phosphate is added to a lithium hydroxide (LiOH) solution, the resulting solution is stirred for a certain period of time, followed by filtration, washing, and drying can be employed. The concentration of the LiOH aqueous solution is not particularly limited. In a case in which the concentration is high, basicity of the reaction solution increases, which might cause α-zirconium phosphate to be partially eluted. Therefore, the concentration is preferably 1 mol/L or less and still more preferably 0.1 mol/L or less.

The component (B) is a lithium ion substitute of α-titanium phosphate.

Ion exchange groups of α-titanium phosphate (unsubstituted α-titanium phosphate) are usually protons. Some or all of the protons are substituted by lithium ions such that the component (B) is formed.

The above-described α-titanium phosphate is a compound represented by the following Formula (2):

TiHₛ(PO₄)ₜ.nH₂O (2)

(where 2<t≤2.1, s is a number satisfying 3t−s=4, and 0≤n≤2).

The amount of lithium ions which are substituted for the compound of Formula (2) is preferably from 0.1 to 7.0 meq/g and more preferably from 1.0 to 7.0 meq/g. In view of ability to trap ions such as Mn²⁺ ions and Ni²⁺ ions, the amount is particularly preferably from 2.0 to 7.0 meq/g.

A method of producing the component (B) is not particularly limited. For example, a method in which α-titanium phosphate is added to a LiOH solution, the resulting solution is stirred for a certain period of time, followed by filtration, washing, and drying can be employed. The concentration of the LiOH aqueous solution is not particularly limited. In a case in which the concentration is high, basicity of the reaction solution increases, which might cause α-titanium phosphate to be partially eluted. Therefore, the concentration is preferably 1 mol/L or less and still more preferably 0.1 mol/L or less.

The component (C) is a lithium ion substitute of aluminium dihydrogen triphosphate. Ion exchange groups of aluminium dihydrogen triphosphate (unsubstituted aluminium dihydrogen triphosphate) are usually protons. Some or all of the protons are substituted by lithium ions such that the component (C) is formed.

The above-described aluminium dihydrogen triphosphate is a compound represented by the following Formula (3):

AlH₂P₃O₁₀.nH₂O (3)

(where n is a positive number).

The amount of lithium ions which are substituted for the compound of Formula (3) is preferably from 0.1 to 6.9 meq/g and more preferably from 1.0 to 6.9 meq/g. In view of ability to trap ions such as Mn²⁺ ions and Ni²⁺ ions, the amount is particularly preferably from 2.0 to 6.9 meq/g.

The lithium ion-containing phosphate usually has a layered structure. In view of ability to trap ions such as Mn²⁺ ions and Ni²⁺ ions and dispersibility in liquid, the upper limit of the median particle size is preferably 5.0 μm, more preferably 3.0 μm, more preferably 2.0 μm, and still more preferably 1.0 μm, and the lower limit thereof is usually 0.03 μm and preferably 0.05 μm. The preferred particle size may be selected depending on types of constituent members to which the ion-trapping agent is applied.

As described above, the ion-trapping agent of the invention may include a lithium ion-containing phosphate and other compounds. Other compounds may be different ion-trapping agents, water, organic solvents, and the like.

The water content of the ion-trapping agent of the invention is preferably 10% by mass or less and more preferably 5% by mass or less. When the water content is 10% by mass or less, in a case in which the ion-trapping agent is used as a member that constitutes a lithium-ion rechargeable battery, it is possible to suppress generation of gas due to electrolysis of water, thereby suppressing expansion of the battery. The water content can be measured by the Karl Fischer method.

A method of setting the water content of the ion-trapping agent to 10% by mass or less is not particularly limited. A method of drying a generally used powder can be applied. For example, a method of heating at atmospheric pressure or under a reduced pressure at from 100° C. to 300° C. for about 6 to 24 hours can be mentioned.

The ion-trapping agent of the invention can be used for a positive electrode, a negative electrode, an electrolyte solution, or a separator as a component of a lithium-ion rechargeable battery. Of these, it is particularly preferable to use the ion-trapping agent of the invention for a positive electrode, an electrolyte solution, or a separator.

The lithium-ion rechargeable battery of the invention is characterized in that it includes a positive electrode, a negative electrode, an electrolyte solution, and a separator, and at least one of the positive electrode, the negative electrode, the electrolyte solution, or the separator contains the ion-trapping agent for a lithium-ion rechargeable battery of the invention. The lithium-ion rechargeable battery of the invention may further include other constituent parts.

(1) Structure

The structure of the lithium-ion rechargeable battery is not particularly limited. However, in general, the lithium-ion rechargeable battery has a structure obtained by winding an electricity storage element comprising a positive electrode, a negative electrode, and a separator into a flat spiral shape to prepare a group of wound-type electrode plates or laminating a positive electrode, a negative electrode, and a separator in a flat plate to prepare a group of laminated-type electrode plates and then sealing the obtained group of electrode plates with an exterior material.

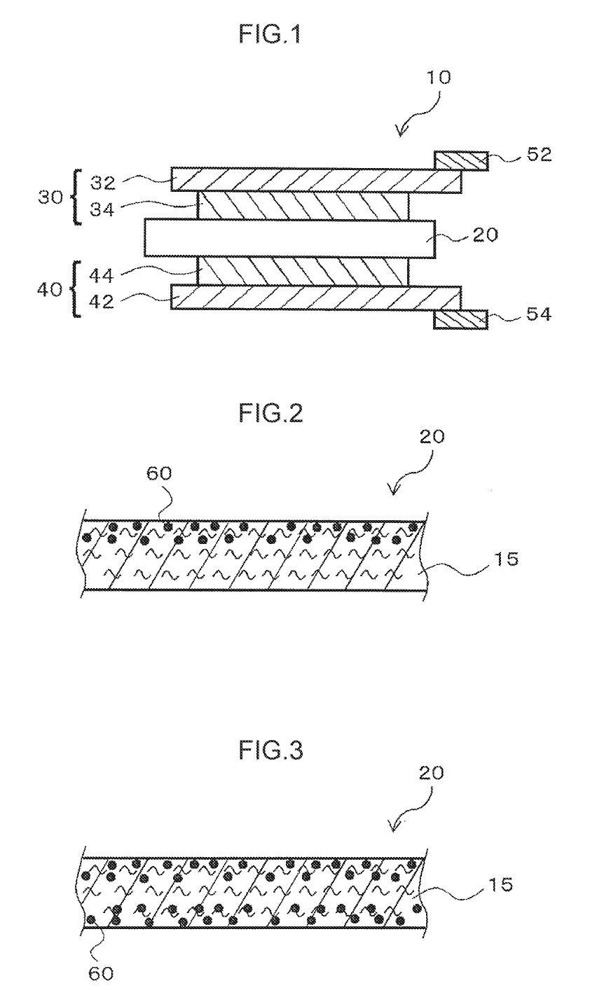

FIG. 1 is one example of a leaded electricity storage element which is sealed with an exterior material. This electricity storage element 10 is a wound body formed by winding a pair of electrodes (positive electrode 30, negative electrode 40) which are disposed to face each other across a separator 20. The positive electrode 30 has a positive electrode current collector 32 on which a positive electrode active material layer 34 is provided, the negative electrode 40 has a negative electrode current collector 42 on which a negative electrode active material layer 44 is provided. The positive electrode active material layer 34 and the negative electrode active material layer 44 are in contact with both sides of the separator 20, respectively. The positive electrode active material layer 34, the negative electrode active material layer 44, and the separator 20 contains an electrolyte solution. In FIG. 1, for example, leads such as aluminum-made leads 52, 54 are joined to an end of the positive electrode current collector 32 and an end of the negative electrode current collector 42, respectively.

It is preferable that the lithium-ion rechargeable battery of the invention contains the ion-trapping agent of the invention in at least either the electrolyte solution or the separator. In general, impurities in an electrolyte solution cause short circuit. In the process of charging and discharging, especially impurity metal ions migrate bi-directionally between a positive electrode and a negative electrode via, for example, a separator. Therefore, in a case in which an ion-trapping agent is contained in at least either an electrolyte solution or a separator, unnecessary metal ions can be trapped more effectively.

(2) Positive Electrode

As described above, the positive electrode as a component of the lithium-ion rechargeable battery, it usually has a positive electrode active material layer on at least a part of the surface of a positive electrode current collector. Examples of a positive electrode current collector that can be used include bands made of metals such as aluminum, titanium, copper, nickel, and stainless steel and alloys in the form of foil, mesh, or the like.

Examples of the positive electrode material used in the positive electrode active material layer include metal compounds, metal oxides, metal sulfides, and conductive polymer materials, which can be doped or intercalated with lithium ions. Specifically, lithium cobaltate (LiCoO₂), lithium nickel oxide (LiNiO₂), lithium manganate (LiMnO₂), and their composites, as well as, conductive polymers such as polyacetylene, polyaniline, polypyrrole, polythiophene, and polyacene, may be used singly, or in combination of two or more kinds thereof.

In a case in which a positive electrode containing the ion-trapping agent is prepared, a method, in which slurry containing a positive electrode material is prepared by using a positive electrode material, an ion-trapping agent, and a binder together with an organic solvent by a dispersion device such as a stirrer, and the slurry is applied to a current collector material, thereby forming a positive electrode active material layer, can be applied. Further, a method, in which a paste-like slurry containing a positive electrode material is molded into a pellet shape or the like and the slurry is integrated with a current collector material, can also be applied.

The concentration of the ion-trapping agent in the slurry containing a positive electrode material can be selected, if appropriate. For example, the concentration may be from 0.01% to 5.0% by mass and preferably from 0.1% to 2.0% by mass.

Examples of the binder include polymer compounds of a styrene-butadiene copolymer, a (meth) acrylic copolymer, polyvinylidene fluoride, polyethylene oxide, polyepichlorohydrin, polyphosphazene, polyimide, and polyamideimide.

The content of the binder in the positive electrode active material layer is preferably from 0.5 to 20 parts by mass and more preferably from 1 to 10 parts by mass with respect to 100 parts by mass in total of the positive electrode, the ion-trapping agent, and the binder. When the content of the binder falls within a range of from 0.5 to 20 parts by mass, the positive electrode active material layer can sufficiently adhere to the current collector material, and an increase in electrode resistance can be suppressed.

As a method of applying the slurry containing a positive electrode material to the current collector material, metal mask printing, electrostatic coating, dip coating, spray coating, roll coating, doctor blade coating, gravure coating, screen printing, or the like can be mentioned

(3) Negative Electrode

The negative electrode as a component of the lithium-ion rechargeable battery usually has a negative electrode active material layer on at least one part of the surface of the negative electrode current collector as described above. Constituent materials for the negative electrode current collector can be the same as constituent materials for the positive electrode current collector. The negative electrode current collector may be formed with a porous material such as a foamed metal or carbon paper.

Examples of the negative electrode material used in the negative electrode active material layer include carbon materials, metal compounds, metal oxides, metal sulfides, and conductive polymer materials, which can be doped or intercalated with lithium ions. Specific examples thereof include natural graphite, artificial graphite, silicon, and lithium titanate, which may be used singly, or in combination of two or more kinds thereof.

In a case in which a negative electrode containing the ion-trapping agent is prepared, a method, in which slurry containing a negative electrode material is prepared by kneading a positive electrode material, an ion-trapping agent, and a binder together with an organic solvent by a dispersion device such as a stirrer, a ball mill, a super sand mill, or a pressure kneader, and the slurry is applied to a current collector material, thereby forming a negative electrode active material layer, can be applied. Further, a method, in which a paste-like slurry containing a negative electrode material is molded into a sheet shape, a pellet shape, or the like and the slurry is integrated with a current collector material, can also be employed.

The ion-trapping agent and the binder used for slurry containing a negative electrode material may be the same as manufacturing materials for the positive electrode, and the contents thereof may be similar to the contents of the manufacturing materials.

In a case in which the slurry containing a negative electrode is applied to the current collector material, a publicly known method can be applied as in the case of the positive electrode.

(4) Electrolyte Solution

An electrolyte solution used in the lithium-ion rechargeable battery of the invention is not particularly limited, and publicly known electrolyte solutions can be used. For example, a nonaqueous lithium-ion rechargeable battery can be produced using an electrolyte solution prepared by dissolving an electrolyte in an organic solvent.

Examples of the electrolyte include anion-producing lithium salts that hardly solvate, such as LiPF₆, LiClO₄, LiBF₄, LiClF₄, LiAsF₆, LiSbF₆, LiAlO₄, LiAlCl₄, LiN(CF₃SO₂)₂, LiN(C₂F₅SO₂)₂, LiC(CF₃SO₂)₃, LiCl, and LiI.

The concentration of the electrolyte is preferably from 0.3 to 5 mol, more preferably from 0.5 to 3 mol, and particularly preferably from 0.8 to 1.5 mol in 1L of an electrolyte solution.

Examples of the organic solvent include the following aprotic solvents: carbonates such as propylene carbonate, ethylene carbonate, diethyl carbonate, dimethyl carbonate, butylene carbonate, vinylene carbonate, fluoroethylene carbonate, ethylmethyl carbonate, methylpropyl carbonate, butylmethyl carbonate, ethylpropyl carbonate, butylethyl carbonate, and dipropyl carbonate; lactones such as γ-butyrolactone; esters such as methyl acetate and ethyl acetate; chain ethers such as 1,2-dimethoxyethane, dimethyl ether, and diethyl ether; cyclic ethers such as tetrahydrofuran, 2-methyltetrahydrofuran, dioxolane, and 4-methyl dioxolane; ketones such as cyclopentanone; sulfolanes such as sulfolane, 3-methyl sulfolane, and 2,4-dimethyl sulfolane; sulfoxides such as dimethyl sulfoxide; nitriles such as acetonitrile, propionitrile, and benzonitrile; amides such as N,N-dimethylformamide and N,N-dimethylacetamide; urethanes such as 3-methyl-1,3-oxazolidin-2-one; and polyoxyalkylene glycols such as diethylene glycol. These organic solvents may be used singly, or in combination of two or more kinds thereof.

An electrolyte solution in the invention contains at least one of the ion-trapping agents described above.

The content of the ion-trapping agent in an electrolyte solution in the present invention is preferably from 0.01% to 50% by mass, more preferably from 0.1% to 30% by mass, and still more preferably from 0.5% to 10% by mass from the viewpoint of suppressing the occurrence of short circuit and internal resistance.

Examples of a method of adding the ion-trapping agent to an electrolyte solution include a method in which the ion-trapping agent in the solid form or dispersion liquid form is added to and mixed in a mixture of an electrolyte and an organic solvent. A method of adding the ion-trapping agent in the solid form is particularly preferable.

In a case in which the ion-trapping agent in the dispersion liquid form is used for producing an electrolyte solution, a solvent for a dispersion liquid is not particularly limited. It is particularly preferable that the solvent is the same as an organic solvent as a component of the electrolyte solution. In addition, the concentration of the ion-trapping agent in the dispersion liquid can be selected, if appropriate. For example, the concentration may be from 0.01% to 50% by mass and it is preferably from 1% to 20% by mass.

(5) Separator

A separator functions to separate a positive electrode and a negative electrode so that short circuit between both electrodes does not occur. Further when excessive current flows in a battery, a separator is melted by heat generation such that micropores are closed, thereby making it possible to shut off the current so as to ensure safety.

The separator is preferably made of a base material having a porous portion (hereinafter referred to as “porous base material”), and its structure is not particularly limited. The porous base material has a large number of pores or voids therein, and it is not particularly limited as long as these holes or the like have a porous structure in which the holes are linked each other. For example, a microporous membrane, nonwoven fabric, a paper-like sheet, a sheet having a three-dimensional network structure, or the like may be used. Of these, a microporous membrane is preferable from the viewpoint of handling ability and strength. As a material that constitutes the porous base material, any organic material or inorganic material can be used. However, from the viewpoint of acquisition of shutdown properties, a thermoplastic resin such as polyolefin resin is preferable.

Examples of the polyolefin resin include polyethylene, polypropylene, and polymethylpentene. Of these, from the viewpoint of acquisition of favorable shutdown properties, a polymer containing ethylene units at 90% by mass or more is preferable. Polyethylene may be any of low-density polyethylene, high-density polyethylene, or ultrahigh-molecular-weight polyethylene. In particular, the polyolefin resin contains preferably at least one selected from high-density polyethylene or ultrahigh-molecular-weight polyethylene and more preferably polyethylene containing a mixture of high-density polyethylene and ultrahigh-molecular-weight polyethylene. Such polyethylene has excellent strength and formability.

The molecular weight of polyethylene is preferably from 100,000 to 10,000,000 in terms of weight average molecular weight. A polyethylene composition containing ultrahigh-molecular-weight polyethylene having a weight average molecular weight of 1,000,000 or more at 1% by mass or more is particularly preferable.

The porous base material may contain polyethylene and other polyolefins such as polypropylene and polymethylpentene, and may be formed with a laminated body of two or more layers, which has a microporous polyethylene film and a microporous polypropylene film.

The separator of the invention includes at least one ion-trapping agent described above.

In the invention, a preferred separator has a portion made of a porous base material and an ion-trapping agent.

The content of the ion-trapping agent in the separator is preferably from 0.01 to 50 g/m² and more preferably from 0.1 to 20 g/m² from the viewpoint of suppression of the occurrence of short circuit.

A preferred structure of the separator of the invention has a layer containing the ion-trapping agent at any portion through one side to the opposite side of the separator and is exemplified below.

(S1) Separator containing an ion-trapping agent 60 in a surface layer on one side of a porous base material 15

FIG. 2 illustrates a separator in this embodiment. However, the separator is not limited thereto and the ion-trapping agent 60 may be present either inside or on the surface of the porous substrate 15.

(S2) Separator containing an ion-trapping agent 60 in a surface layer on each side of a porous base material 15

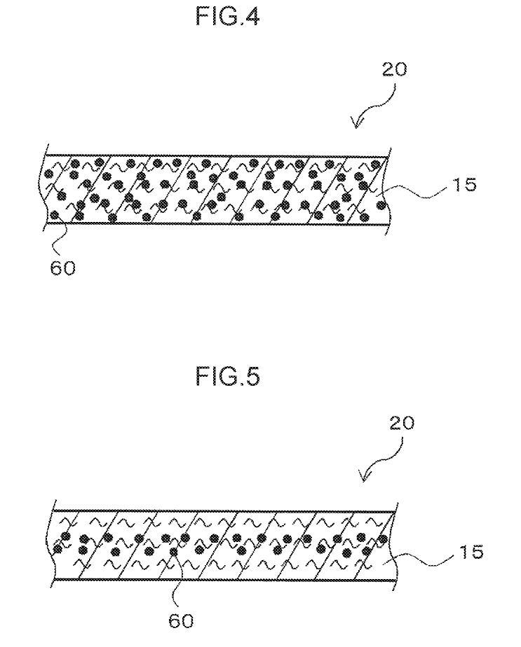

FIG. 3 illustrates a separator in this embodiment. However, the separator is not limited thereto and the ion-trapping agent 60 may be present either inside or on the surface of the porous substrate 15.

(S3) Separator containing an ion-trapping agent 60 evenly through one side to the opposite side of a porous base material 15

FIG. 4 illustrates a separator in this embodiment. However, the separator is not limited thereto and the ion-trapping agent 60 may be present either inside or on the surface of the porous substrate 15.

(S4) Separator containing an ion-trapping agent 60 in the layered form inside of a porous base material 15

FIG. 5 illustrates a separator in this embodiment. However, the separator is not limited thereto. A porous substrate 15 may include a plurality of layers containing an ion-trapping agent.

In the case of a separator 20 shown in the embodiment (S1) of FIG. 2, the side on which the ion-trapping agent 60 is contained may be arranged on either the positive electrode side or the negative electrode side in a lithium-ion rechargeable battery. In consideration of the fact that metal ions are eluted from a positive electrode or metals are deposited on a negative electrode as a result of reduction of metal ions, the side is preferably arranged on the positive electrode side. A separator 20 shown in the embodiment (S2) of FIG. 3, in which the ion-trapping agent 60 is disposed in the surface layer of each side, is also preferable.

The separators in the embodiments (S1) and (S2) described above can be produced by a method comprising sequentially a step of coating a surface layer portion of either one of or both of the surfaces of a porous base material with a dispersion liquid containing an ion-trapping agent and a step of forming a layer containing the ion-trapping agent by drying the coating or a method comprising sequentially a step of immersing a surface layer portion of either one of or both of the surfaces of a porous base material in a dispersion liquid containing an ion-trapping agent and a step of forming a layer containing the ion-trapping agent by drying the coating.

The separator in the embodiment (S3) can be produced by a method comprising sequentially a step of immersing a porous base material in a dispersion liquid containing an ion-trapping agent and a step of drying the coated porous base material.

The separator in the embodiment (S4) can be produced by a method comprising sequentially a step of coating the surface of one side of a porous base material with a dispersion liquid containing an ion-trapping agent, a step of forming a layer containing the ion-trapping agent by drying the coating, and a step of joining a different porous base material to the ion-trapping agent-containing layer or a method comprising sequentially a step of immersing the surface of one side of a porous base material in a dispersion liquid containing an ion-trapping agent, a step of forming a layer containing the ion-trapping agent by drying the coating, and a step of joining a different porous base material to the ion-trapping agent-containing layer.

A solvent for the dispersion liquid containing an ion-trapping agent is not particularly limited. Examples thereof include water, N-methyl-2-pyrrolidone, and alcohols such as methanol, ethanol, and 1-propanol.

The concentration of the ion-trapping agent in the dispersion liquid can be selected, if appropriate. For example, the concentration may be from 0.01% to 50% by mass and preferably from 1% to 20% by mass.

The dispersion liquid may further contain a binder. In a case in which the dispersion liquid containing an ion-trapping agent includes a binder, the ion-trapping agent is securely fixed to a porous base material. Accordingly, the ion-trapping agent is not detached when a battery is produced, thereby making it possible to trap unnecessary metal ions with improved efficiency.

The binder is not particularly limited. However, it is preferably a binder which can favorably adhere the lithium ion-containing phosphate and the porous base material, and which is electrochemically stable and further stable with respect to an electrolyte solution. Examples of such binder include fluorine resins such as an ethylene-vinyl acetate copolymer, an ethylene-ethyl acrylate copolymer, an ethylene-acrylic acid copolymer, polyvinylidene fluoride, a vinylidene fluoride-hexafluoropropylene copolymer, and a vinylidene fluoride-trichlorethylene copolymer, fluorine rubber, styrene-butadiene rubber, nitrile-butadiene rubber, polybutadiene rubber, polyacrylonitrile, polyacrylic acid, carboxymethyl cellulose, hydroxyethyl cellulose, polyvinyl alcohol, cyanoethyl polyvinyl alcohol, polyvinyl butyral, polyvinyl pyrrolidone, poly(N-vinyl acetamide), polyether, polyamide, polyimide, polyamideimide, polyaramid, a crosslinked acrylic resin, polyurethane, and an epoxy resin. In the invention, polyvinyl alcohol, polyvinylidene fluoride, styrene-butadiene rubber, polyacrylic acid, and carboxymethyl cellulose are preferable. In consideration of the fact that the binder is a constituent material for a battery, the binder is preferably similar to any binder used for a positive electrode active material layer or a negative electrode active material layer.

The amount of a binder used (solid content) is preferably from 0.1 to 20 parts by weight and more preferably from 0.3 to 10 parts by weight with respect to 100 parts by mass in total of an ion-trapping agent and a binder. When the amount of a binder used falls within a range of from 0.1 to 20 parts by mass, an ion-trapping agent is effectively fixed to a porous base material such that the effects of the ion-trapping agent can be continuously obtained. Further, it is possible to improve the metal adsorption efficiency per mass.

A method of coating a porous base material with the dispersion liquid is not particularly limited. Known methods such as metal mask printing, electrostatic coating, dip coating, spray coating, roll coating, reverse roll coating, transfer roll coating, kiss coating, knife coating, rod coating, squeeze coating, cast coating, die coating, doctor blade coating, gravure coating, and screen printing can be applied.

The separator of the invention may be formed with a laminated body, in which an independent layer containing an ion-trapping agent is formed on either one of or both of the sides of a porous base material, or a laminated body, in which an independent layer containing an ion-trapping agent is provided between two porous base materials, both of which are not shown.

In the invention, for the separator in each embodiment described above, the thickness of the ion-trapping agent-containing layer is as follows. The lower limit of the thickness is preferably 0.5 μm, more preferably 2 μm, still more preferably 3 μm, and particularly preferably 4 μm from the viewpoint of ion trapping ability. In addition, the upper limit of the thickness is preferably 90 μm, more preferably 50 μm, still more preferably 30 μm, and particularly preferably 10 μm from the viewpoints of electrolyte solution permeability and improvement of high-capacity battery,

The number of separators included in the lithium-ion rechargeable battery of the invention is not particularly limited. It can be selected depending on a battery structure, if appropriate.

A preferred embodiment of the lithium-ion rechargeable battery of the invention is exemplified below.

(L1) A battery containing the ion-trapping agent of the invention only in a positive electrode
(L2) A battery containing the ion-trapping agent of the invention only in an electrolyte solution
(L3) A battery containing the ion-trapping agent of the invention only in a separator (a battery including the separator of the invention)
(L4) A battery containing the ion-trapping agent of the invention in a positive electrode and an electrolyte solution
(L5) A battery containing the ion-trapping agent of the invention in a positive electrode and a separator (a battery including the separator of the invention)
(L6) A battery containing the ion-trapping agent of the invention in an electrolyte solution and a separator (a battery including the separator of the invention)
(L7) A battery containing the ion-trapping agent of the invention in a positive electrode, an electrolyte solution, and a separator (a battery including the separator of the invention)

Of these, the embodiments (L3), (L5), and (L6) are preferable. In addition, in the embodiments (L3), (L5), (L6), and (L7), it is particularly preferable that a separator, in which an ion-trapping agent-containing layer is disposed at least on the positive electrode side, is provided.

In the embodiments (L4), (L5), (L6), and (L7), the contained ion-trapping agent may be the same or different at the respective portions.

It is possible to obtain a lithium-ion rechargeable battery, which includes a positive electrode and a negative electrode without a separator, using the electrolyte solution of the invention. In this case, positive and negative electrodes are configured not to be in direct contact with each other such that a separator is not required.

### EXAMPLES

The invention is specifically explained based on the Examples below. However, the invention is not limited to the following Examples.

1. Method of Evaluating Ion-Trapping Agent

(1) Water Content

After an ion-trapping agent was vacuum-dried at 150° C. for 20 hours, the water content was determined by the Karl Fischer method.

(2) Measurement of pH

The pH of a liquid obtained after the addition of an ion-trapping agent in (3) below was measured by a glass electrode-type hydrogen ion concentration indicator “D-51” (model name) manufactured by Horiba Ltd. Measurement was conducted in accordance with JIS Z-8802 “pH Measurement Method” at 25° C.

(3) Metal Ion Trapping Ability of Ion-Trapping Agent in Metal Ion-Containing Aqueous Solution

Metal ion trapping ability was evaluated by the ICP emission spectrometric analysis method. The evaluation method is specifically described as follows.

First, regarding Li⁺, the Ni²⁺, or Mn²⁺, a 100 ppm metal ion solution was prepared using a metal sulfate of each ion and pure water. An ion-trapping agent was added to each prepared solution to result in a concentration of 1.0% by mass. Each solution was sufficiently mixed and allowed to stand still. Then, the metal ion concentration in each solution 20 hours after the addition of an ion-trapping agent was determined using an ICP emission spectrophotometer “iCA7600 DUO” (model name) manufactured by Thermo Fisher Scientific Inc.

(4) Metal Ion Trapping Ability in Model Electrolyte Solution

Assuming the application to a lithium-ion rechargeable battery, metal ion trapping ability in a model electrolyte solution was evaluated. A solution prepared by mixing diethyl carbonate (DEC) and ethylene carbonate (EC) at a volume ratio of DEC/EC=1/1 was used as a solvent. In addition, nickel tetrafluoroborate was used as a solute.

First, the solute was added to a certain amount of the solvent such that the initial Ni²⁺ ion concentration was adjusted to 100 ppm by mass. Thus, a model electrolyte solution was prepared.

Then, 30 mL of this model electrolyte solution was introduced into a glass bottle, and 0.3 g of an ion-trapping agent was added thereto. The resulting liquid mixture was stirred for about 1 minute at 25° C. and then was allowed to stand still at 25° C. About 20 hours thereafter, the Ni²⁺ ion concentration was determined by an ICP emission spectrophotometer “iCA7600 DUO” (model name) manufactured by Thermo Fisher Scientific Inc. Acid degradation (microwave method) was carried out as pretreatment of measurement samples.

2. Production and Evaluation of Ion-Trapping Agent

### Synthesis Example 1

Zirconium oxychloride octahydrate in an amount of 0.272 mol was dissolved in 850 mL of deionized water. Then, 0.788 mol of oxalic acid dihydrate was added and dissolved therein. Subsequently, while this aqueous solution was stirred, 0.57 mol of phosphoric acid was added thereto. The resulting liquid mixture was refluxed at 103° C. for 8 hours during stirring. After cooling, the obtained precipitate was sufficiently washed with water and dried at 150° C. Accordingly, a powder comprising zirconium phosphate was obtained. As a result of analysis, the obtained zirconium phosphate was confirmed to be α-zirconium phosphate (H type) (hereinafter referred to as “α-zirconium phosphate (Z1)”).

The α-zirconium phosphate (Z1) was boiled and dissolved in nitric acid with the addition of hydrofluoric acid. Thereafter, the following composition formula was obtained by the ICP emission spectrometric analysis method.

ZrH_{2.03}(PO₄)_{2.01}.0.05H₂O

In addition, the median diameter of α-zirconium phosphate (Z1) was measured using a laser diffraction particle size distribution analyzer “LA-700” (model name) manufactured by Horiba Ltd. As a result, the median diameter was 0.9 μm.

### Example 1

The α-zirconium phosphate (Z1) in an amount of 100 g obtained in Synthesis Example 1 was added to 1000 mL of a 0.1 N—LiOH solution during stirring, and the resulting liquid mixture was stirred for 8 hours. Then, the precipitate was washed with water and vacuum-dried at 150° C. for 20 hours, thereby producing a lithium ion-substituted α-zirconium phosphate comprising ZrLi_{0.3}H_{1.73}(PO₄)_{2.01}.0.06H₂O. The water content was 0.4%. This lithium ion-substituted α-zirconium phosphate, in which ion exchange groups accounting for 1 meq/g out of the total cation exchange capacity were substituted by lithium ions, is hereinafter referred to as “1 meq-Li-substituted α-zirconium phosphate (A1-1).”

Then, evaluation described in (3) and (4) above was conducted using the 1 meq-Li-substituted α-zirconium phosphate (A1-1) as an ion-trapping agent, and the results are shown in Table 1.

### Example 2

The procedure in this Example was performed as described in Example 1 except that the amount of the 0.1N—LiOH aqueous solution used was 3000 mL, thereby producing a lithium ion-substituted α-zirconium phosphate comprising ZrLi_{1.03}H_{1.00}(PO₄)_{2.01}.0.1H₂O. The water content was 0.3%. The lithium ion-substituted α-zirconium phosphate is hereinafter referred to as “3 meq-Li-substituted α-zirconium phosphate (A1-2).”

Then, evaluation described in (3) and (4) above was conducted using the 3 meq-Li-substituted α-zirconium phosphate (A1-2) as an ion-trapping agent, and the results are shown in Table 1.

### Example 3

The procedure in this Example was performed as described in Example 1 except that the amount of the 0.1N—LiOH aqueous solution used was 7000 mL, thereby producing a lithium ion-substituted α-zirconium phosphate comprising ZrLi_{2.03}(PO₄)_{2.01}.0.2H₂O. The water content was 0.3%. This lithium ion-substituted α-zirconium phosphate, in which ion exchange groups accounting for the total cation exchange capacity (6.7 meq/g) were substituted by lithium ions, is hereinafter referred to as “wholly-Li-substituted α-zirconium phosphate (A1-3).”

Then, evaluation described in (3) and (4) above was conducted using the wholly-Li-substituted α-zirconium phosphate (A1-3) as an ion-trapping agent, and the results are shown in Table 1.

### Synthesis Example 2

75% phosphoric acid in an amount of 405 g was added to 400 mL of deionized water. While this aqueous solution was stirred, 137 g of titanyl sulfate (TiO₂-converted content: 33%) was added thereto. Then, the resulting solution was refluxed at 100° C. for 48 hours during stirring. After cooling, the obtained precipitate was sufficiently washed with water and dried at 150° C. Accordingly, a powder comprising titanium phosphate was obtained. As a result of analysis, the obtained titanium phosphate was confirmed to be α-titanium phosphate (H type).

The α-titanium phosphate was boiled and dissolved in nitric acid with the addition of hydrofluoric acid. Thereafter, the following composition formula was obtained by the ICP emission spectrometric analysis method.

TiH_{2.03}(PO₄)_{2.01}.0.1H₂O

In addition, as a result of measurement of the median diameter of α-titanium phosphate, the median diameter was 0.7 μm.

### Example 4

The α-titanium phosphate in an amount of 100 g obtained in Synthesis Example 2 was added to 1000 mL of a 0.1 N—LiOH solution during stirring, and the resulting liquid mixture was stirred for 8 hours. Then, the precipitate was washed with water and vacuum-dried at 150° C., thereby producing a lithium ion-substituted α-titanium phosphate comprising TiLi_{0.3}H_{1.73}(PO₄)_{2.01}.0.2H₂O. The water content was 0.5%. The lithium ion-substituted α-titanium phosphate, in which ion exchange groups accounting for 1 meq/g out of the total cation exchange capacity were substituted by lithium ions, is hereinafter referred to as “1-meq Li-substituted α-titanium phosphate (B-1).”

Then, evaluation described in (3) and (4) above was conducted using the 1 meq-Li-substituted α-titanium phosphate (B-1) as an ion-trapping agent, and the results are shown in Table 1.

### Example 5

The procedure in this Example was performed as described in Example 4 except that the amount of the 0.1N—LiOH aqueous solution used was changed to 3000 mL, thereby producing a lithium ion-substituted α-titanium phosphate comprising TiLi_{1.00}H_{1.03}(PO₄)_{2.01}.0.1H₂O. The water content was 0.3%. The lithium ion-substituted α-titanium phosphate is hereinafter referred to as “3 meq-Li-substituted α-titanium phosphate (B-2).”

Then, evaluation described in (3) and (4) above was conducted using the 3 meq-Li-substituted α-titanium phosphate (B-2) as an ion-trapping agent, and the results are shown in Table 1.

### Example 6

The procedure in this Example was performed as described in Example 4 except that the amount of the 0.1N—LiOH aqueous solution used was changed to 7000 mL, thereby producing a lithium ion-substituted α-titanium phosphate comprising TiLi_{2.03}(PO₄)_{2.01}.0.1H₂O. The water content was 0.3%. This lithium ion-substituted α-titanium phosphate, in which ion exchange groups accounting for the total cation exchange capacity (7.0 meq/g) were substituted by lithium ions, is hereinafter referred to as “wholly-Li-substituted α-titanium phosphate (B-3).”

Then, evaluation described in (3) and (4) above was conducted using the wholly-Li-substituted α-titanium phosphate (B-3) as an ion-trapping agent, and the results are shown in Table 1.

### Synthesis Example 3

Zirconium oxychloride octahydrate having a Hf content of 0.18% in an amount of 0.272 mol was dissolved in 850 mL of deionized water. Then, 0.788 mol of oxalic acid dihydrate was added and dissolved therein. Subsequently, while this aqueous solution was stirred, 0.57 mol of phosphoric acid was added thereto. The resulting liquid mixture was refluxed at 98° C. for 8 hours during stirring. After cooling, the obtained precipitate was sufficiently washed with water and dried at 150° C. Accordingly, a scale-like powder comprising zirconium phosphate was obtained. As a result of analysis, the zirconium phosphate was confirmed to be α-zirconium phosphate (H type) (hereinafter referred to as “α-zirconium phosphate (Z2)”).

The α-zirconium phosphate (Z2) was boiled and dissolved in nitric acid with the addition of hydrofluoric acid. Thereafter, the following composition formula was obtained by ICP emission spectrometric analysis.

Zr_{0.99}Hf_{0.01}H_{2.03}(PO₄)_{2.0}.0.05H₂O

In addition, the median diameter of α-zirconium phosphate (Z2) was 0.8 μm.

### Example 7

The α-zirconium phosphate (Z2) in an amount of 100 g obtained in Synthesis Example 3 was added to 1000 mL of a 0.1 N—LiOH solution during stirring, and the resulting liquid mixture was stirred for 8 hours. Then, the precipitate was washed with water and vacuum-dried at 150° C. for 20 hours, thereby producing a lithium ion-substituted α-zirconium phosphate comprising Zr_{0.99}Hf_{0.01}Li_{0.3}H_{1.73}(PO₄)_{2.01}.0.07H₂O. The water content was 0.4%. This lithium ion-substituted α-zirconium phosphate, in which ion exchange groups accounting for 1 meq/g out of the total cation exchange capacity were substituted by lithium ions, is hereinafter referred to as “1 meq-Li-substituted α-zirconium phosphate (A2-1).”

Then, evaluation described in (3) and (4) above was conducted using the 1 meq-Li-substituted α-zirconium phosphate (A2-1) as an ion-trapping agent, and the results are shown in Table 1.

### Example 8

The procedure in this Example was performed as described in Example 7 except that the amount of the 0.1N—LiOH aqueous solution used was 3000 mL, thereby producing a lithium ion-substituted α-zirconium phosphate comprising Zr_{0.99}Hf_{0.01}Li_{1.03}H_{1.00}(PO₄)_{2.01}.0.1H₂O. The water content was 0.3%. The lithium ion-substituted α-zirconium phosphate is hereinafter referred to as “3 meq-Li-substituted α-zirconium phosphate (A2-2).”

Then, evaluation described in (3) and (4) above was conducted using the 3 meq-Li-substituted α-zirconium phosphate (A2-2) as an ion-trapping agent, and the results are shown in Table 1.

### Example 9

The procedure in this Example was performed as described in Example 7 except that the amount of the 0.1N—LiOH aqueous solution used was 7000 mL, thereby producing a lithium ion-substituted α-zirconium phosphate comprising Zr_{0.99}Hf_{0.01}Li_{2.03}(PO₄)_{2.01}.0.2H₂O. The water content was 0.3%. This lithium ion-substituted α-zirconium phosphate, in which ion exchange groups accounting for the total cation exchange capacity (6.7 meq/g) were substituted by lithium ions, is hereinafter referred to as “wholly-Li-substituted α-zirconium phosphate (A2-3).”

Then, evaluation described in (3) and (4) above was conducted using the wholly-Li-substituted α-zirconium phosphate (A2-3) as an ion-trapping agent, and the results are shown in Table 1.

### Example 10

Aluminium dihydrogen triphosphate “K-FRESH #100P” (trade name) manufactured by Tayca Corporation was ground in a bead mill, thereby obtaining a fine powder. Then, 100 g of the fine powder was added to a 0.1N—LiOH aqueous solution. The resulting mixture was stirred for 8 hours, followed by washing with water and filtration. The residue was dried at 150° C., thereby producing lithium ion-substituted aluminium dihydrogen triphosphate comprising AlLi₂P₃O₁₀.0.2H₂O. The median diameter was 0.8 μm, and the water content was 0.3%. This lithium ion-substituted aluminium dihydrogen triphosphate, in which ion exchange groups accounting for the total cation exchange capacity (6.9 meq/g) were substituted by lithium ions, is hereinafter referred to as “wholly-Li-substituted tripolyphosphate aluminum dihydrogen phosphate (C-1).”

Then, evaluation described in (3) and (4) above was conducted using the wholly-Li-substituted tripolyphosphate aluminum dihydrogen phosphate (C-1) as an ion-trapping agent, and the results are shown in Table 1.

### Comparative Example 1

A 350 mmol/L sodium orthosilicate aqueous solution in an amount of 500 mL was added to 500 mL of a 700 mmol/L aluminum chloride aqueous solution, followed by stirring for 30 minutes. Then, 330 mL of a 1 mol/L sodium hydroxide aqueous solution was added to the liquid mixture such that pH was adjusted to 6.1.

The pH-adjusted liquid was stirred for 30 minutes and then centrifuged for 5 minutes. After centrifugation, the supernatant was removed. Then, pure water was added to the collected gel-like precipitate in order to redisperse the precipitate, thereby adjusting the total volume to the pre-centrifugation volume. Desalting involving centrifugation was repeated three times in the above manner.

Next, the dispersion liquid was placed in a dryer and heated at 98° C. for 48 hours. Thus, a dispersion liquid having an aluminum silicate concentration of 47 g/L was obtained. Then, 188 mL of a 1 mol/L sodium hydroxide aqueous solution was added to the dispersion liquid, thereby adjusting pH to 9.1. Aluminum silicate in the liquid was aggregated by pH adjustment. Thereafter, the agglomerate was precipitated by centrifugation for 5 minutes and the supernatant was removed. Then, pure water was added to the recovered agglomerate, thereby adjusting the total volume to the pre-centrifugation volume. Desalting was repeated three times in the above manner.

The gel-like precipitate obtained after discharge of the supernatant in the third instance of desalting was dried at 60° C. for 16 hours, thereby obtaining 30 g of a powder. This powder is hereinafter referred to as “aluminum silicate.”

Then, evaluation described in (3) and (4) above was conducted using the aluminum silicate as an ion-trapping agent, and the results are shown in Table 1.

### Comparative Example 5

A commercially available Y-type zeolite “MIZUKASIEVES Y-520” (manufactured by Mizusawa Industrial Chemicals, Ltd.) in an amount of 50 g was added to 10 L of a 0.05 M-HNO₃ solution and stirred at room temperature for 8 hours. Thereafter, the precipitate was washed with water and dried at 150° C. for 20 hours, thereby obtaining sodium-free zeolite. Then, 10 g of the zeolite was added to 1 L of a 0.1 M-LiOH aqueous solution and stirred for 8 hours. Subsequently, the precipitate was washed with water and dried at 150° C. for 20 hours. Thus, “Li-substituted Y-type zeolite” was obtained.

Then, evaluation described in (3) and (4) above was conducted using the Li-substituted Y-type zeolite as an ion-trapping agent, and the results are shown in Table 1.

In the Comparative Examples other than the above, the following materials were used as ion-trapping agents. These ion-trapping agents were dried at 150° C. for 20 hours before use.

### Comparative Example 2

Activated carbon (reagent) “in the crushed form 2 mm to 5 mm in length” manufactured by Wako Pure Chemical Industries, Ltd.

### Comparative Example 3

Silica gel (reagent) “in the small granular form (white)” manufactured by Wako Pure Chemical Industries, Ltd.

### Comparative Example 4

Y-type zeolite “MIZUKASIEVES Y-520” (trade name) manufactured by Mizusawa Industrial Chemicals, Ltd.

### Comparative Example 6

α-zirconium phosphate (Z1) synthesized in Synthesis Example 1

### Comparative Example 7

α-titanium phosphate synthesized in Synthesis Example 2

### Comparative Example 8

Hydrotalcite “DHT-4H” (trade name) manufactured by Kyowa Chemical Industry Co., Ltd.

TABLE 1

| | | Evaluation (3) | | | | Evaluation (4) |
|---|---|---|---|---|---|---|
| | | Concentration after addition | | | | Ni²⁺ concentration after |
| | | of ion-trapping agent (ppm) | | | | addition of ion-trapping |
| Ion-trapping agent | | Ni²⁺ | Mn²⁺ | Li⁺ | pH | agent (ppm) |
| Example 1 | 1 meq-Li-substituted α-zirconium phosphate (A1-1) | 4 | 1 | 120 | 7.0 | 8 |
| Example 2 | 3 meq-Li-substituted α-zirconium phosphate (A1-2) | <1 | <1 | 120 | 7.2 | <1 |
| Example 3 | Wholly Li-substituted α-zirconium phosphate (A1-3) | <1 | <1 | 135 | 7.4 | <1 |
| Example 4 | 1 meq-Li-substituted α-titanium phosphate (B-1) | 5 | 1 | 105 | 7.0 | 12 |
| Example 5 | 3 meq-Li-substituted α-titanium phosphate (B-2) | <1 | <1 | 110 | 7.1 | <1 |
| Example 6 | Wholly Li-substituted α-titanium phosphate (B-3) | <1 | <1 | 115 | 7.3 | <1 |
| Example 7 | 1 meq-Li-substituted α-zirconium phosphate (A2-1) | 3 | 1 | 120 | 7.0 | 7 |
| Example 8 | 3 meq-Li-substituted α-zirconium phosphate (A2-2) | <1 | <1 | 120 | 7.2 | <1 |
| Example 9 | Wholly Li-substituted α-zirconium phosphate (A2-3) | <1 | <1 | 133 | 7.3 | <1 |
| Example 10 | Wholly Li-substituted aluminium dihydrogen triphosphate (c-1) | <1 | <1 | 119 | 7.3 | <1 |
| Comparative Example 1 | Aluminum silicate | 3 | 10 | 90 | 5.4 | 20 |
| Comparative Example 2 | Activated carbon | 50 | 60 | 100 | 7.0 | 100 |
| Comparative Example 3 | Silica gel | 100 | 100 | 80 | 8.5 | 100 |
| Comparative Example 4 | Y-type zeolite | 30 | 36 | 80 | 9.0 | 80 |
| Comparative Example 5 | Li-substituted Y-type zeolite | <1 | <1 | 140 | 9.0 | 20 |
| Comparative Example 6 | α-zirconium phosphate (Z1) | 94 | 56 | 100 | 2.8 | 100 |
| Comparative Example 7 | α-titanium phosphate | 90 | 60 | 100 | 3.0 | 100 |
| Comparative Example 8 | Hydrotalcite | 76 | 99 | 100 | 8.0 | 100 |

As is apparent from Table 1, it is understood that the ion-trapping agents of Examples 1 to 10 selectively trap Ni²⁺ and Mn²⁺ in water and have excellent ion adsorption capacity. Also in the test using the model electrolyte solution, the ion-trapping agents of Examples 1 to 10 exhibited high ion trapping ability. These results indicate that the ion-trapping agent of the invention traps Ni²⁺ and Mn²⁺, which are unnecessary in a lithium-ion rechargeable battery, but does not trap Li⁺, which is essential for charging and discharging. Therefore, the ion-trapping agent of the invention can suppress the occurrence of short circuit without inhibiting the performance of the lithium-ion rechargeable battery.

Further, since the liquid containing any of the ion-trapping agents of Examples 1 to 10 was neutral, resistance would not increase even in a case in which the ion-trapping agents of Examples 1 to 10 are each mixed in an electrolyte solution.

3. Production and Evaluation of Separator

An ion-trapping agent processing liquid was prepared using each of the ion-trapping agents, polyvinyl alcohol, and the like. Thereafter, each ion-trapping agent processing liquid was applied to a porous polyethylene film (porous base material) having a porosity of from 50% to 60% and a thickness of 20 thereby obtaining separators each containing an ion-trapping agent.

Then, a Ni²⁺ ion trapping test was conducted using the obtained separators and a nonaqueous electrolyte solution manufactured by Kishida Chemical Co., Ltd. Note that the nonaqueous electrolyte solution is a solvent obtained by mixing ethylene carbonate (EC) and ethyl methyl carbonate (EMC) at a volume ratio of EC/EMC= 3/7 and adding 1M-LiBF₄ as a supporting electrolyte.

First, Ni(BF₄).6H₂O was dissolved in the non-aqueous electrolyte solution so as to adjust the concentration of Ni²⁺ to 100 ppm by mass, thereby preparing a test solution. In a petri dish with a diameter of 9 cm, each separator (50 mm×50 mm) and 10 mL of the test solution were introduced, a cover was placed on it, and the petri dish was allowed to stand still at 25° C. Twenty hours thereafter, the separator was taken out. The test solution was collected and diluted 100-fold with ion-exchange water. Then, the concentration of Ni²⁺ ion in this diluted solution was measured by ICP emission spectrophotometer “iCA7600 DUO” (model name) manufactured by Thermo Fisher Scientific Inc. The results obtained are shown in Table 2.

### Example 11

The wholly-Li-substituted α-zirconium phosphate (A1-3) obtained in Example 3, polyvinyl alcohol (average polymerization degree: 1700, saponification degree of 99% or more), and ion-exchanged water were used at proportions of 5 parts by mass, 95 parts by mass, and 100 parts by mass, respectively. These were placed in a polypropylene container together with zirconium oxide beads “TORAYCERAM” (registered trademark) having a diameter of 0.5 mm manufactured by Toray Industries, Inc. and dispersed for 4 hours using a paint shaker manufactured by Toyo Seiki Seisaku-sho, Ltd. Thereafter, the obtained dispersion liquid was filtered through a filter having a filtration limit of 5 μm, thereby obtaining an ion-trapping agent processing liquid.

Next, the ion-trapping agent processing liquid was applied on one side of the porous base material (polyethylene film) by gravure coating, thereby obtaining a coating film having a thickness of 10 μm. Then, the coating film was passed through a hot-air drying oven at 50° C. for 10 seconds for drying and fixation, thereby obtaining a separator (S1) having the cross-sectional structure of FIG. 2 and a thickness of 25 μm. This separator (S1) was calcined at 1000° C. for 2 hours. The amount of wholly-Li-substituted α-zirconium phosphate (A1-3) supported was calculated from the calcination residue and found to be 1.0 mg/cm².

### Example 12

The wholly-Li-substituted α-zirconium phosphate obtained in Example 3 (A1-3) was heated in vacuum at 150° C. for 20 hours and then heated at 350° C. for 4 hours, thereby obtaining a calcined matter. The obtained calcined matter was represented by ZrLi_{2.03}(PO₄)_{2.01}, and the median particle size was 0.9 μm.

Thereafter, an ion-trapping agent processing liquid was prepared and a separator was produced in the same manner as in Example 11 except that the calcined matter was used instead of wholly-Li-substituted α-zirconium phosphate (A1-3). The thickness of the obtained separator (S2) was 25 μm, and the amount of calcined matter supported was 1.1 mg/cm².

### Example 13

An ion-trapping agent processing liquid was prepared and a separator was produced in the same manner as in Example 11 except that 3 meq-Li-substituted α-zirconium phosphate (A1-2) was used instead of wholly-Li-substituted α-zirconium phosphate (A1-3). The thickness of the obtained separator (S3) was 25 μm, and the amount of 3 meq-Li-substituted α-zirconium phosphate (A1-2) supported was 1.0 mg/cm².

### Example 14

An ion-trapping agent processing liquid was prepared and a separator was produced in the same manner as in Example 11 except that wholly-Li-substituted α-titanium phosphate (B-3) was used instead of wholly-Li-substituted α-zirconium phosphate (A1-3). The thickness of the obtained separator (S4) was 25 μm, and the amount of wholly-Li-substituted α-titanium phosphate (B-3) supported was 0.8 mg/cm².

### Example 15

An ion-trapping agent processing liquid was prepared and a separator was produced in the same manner as in Example 11 except that 3 meq-Li-substituted α-titanium phosphate (B-2) was used instead of wholly-Li-substituted α-zirconium phosphate (A1-3). The thickness of the obtained separator (S5) was 25 μm, and the amount of 3 meq-Li-substituted α-titanium phosphate (B-2) supported was 0.8 mg/cm².

### Example 16

An ion-trapping agent processing liquid was prepared and a separator was produced in the same manner as in Example 11 except that wholly-Li-substituted aluminium dihydrogen triphosphate (C-1) was used instead of wholly-Li-substituted α-zirconium phosphate (A1-3). The thickness of the obtained separator (S6) was 25 μm, and the amount of wholly-Li-substituted aluminium dihydrogen triphosphate (C-1) supported was 1.1 mg/cm².

### Example 17

A separator (S7) supporting an ion-trapping agent processing liquid on both sides thereof was obtained in the same manner as in Example 11 except that the ion-trapping agent processing liquid prepared in Example 11 was applied to both sides of the porous base material (polyethylene film). The thickness of the obtained separator (S7) was 30 μm, and the amount of wholly-Li-substituted α-zirconium phosphate (A1-3) supported was 2.0 mg/cm² in total.

### Example 18

A separator (S8) having the cross-sectional structure of FIG. 2 was obtained in the same manner as in Example 11 except that the amount of the ion-trapping agent processing liquid prepared in Example 11 was reduced. The thickness of the obtained separator (S8) was 23 μm, and the amount of wholly-Li-substituted α-zirconium phosphate (A1-3) supported was 0.5 mg/cm².

### Example 19

A separator (S9) having the cross-sectional structure of FIG. 2 was obtained in the same manner as in Example 11 except that the amount of the ion-trapping agent processing liquid prepared in Example 11 was increased. The thickness of the obtained separator (S9) was 35 μm, and the amount of wholly-Li-substituted α-zirconium phosphate (A1-3) supported was 3.0 mg/cm².

### Example 20

A separator (S10) having the cross-sectional structure of FIG. 2 was obtained in the same manner as in Example 11 except that the wholly-Li-substituted α-zirconium phosphate (A1-3) obtained in Example 3, polyvinyl alcohol (average polymerization degree: 1700, saponification degree of 99% or more), and ion-exchanged water were used at proportions of 85 parts by mass, 15 parts by mass, and 100 parts by mass, respectively, and an ion-trapping agent processing liquid prepared in the same manner as in Example 11 was used. The thickness of the obtained separator (S10) was 25 and the amount of wholly-Li-substituted α-zirconium phosphate (A1-3) supported was 0.9 mg/cm².

### Comparative Example 9

The porous base material (polyethylene film) alone was evaluated as a separator (S11).

### Comparative Example 10

An ion-trapping agent processing liquid was prepared and a separator was produced in the same manner as in Example 11 except that alumina particles having a median diameter 0.8 μm were used instead of wholly-Li-substituted α-zirconium phosphate (A1-3). The thickness of the obtained separator (S12) was 25 and the amount of alumina particles supported was 1.6 mg/cm².

### Comparative Example 11

An ion-trapping agent processing liquid was prepared and a separator was produced in the same manner as in Example 11 except that α-zirconium phosphate (Z1) prepared in Synthesis Example 1 was used instead of wholly-Li-substituted α-zirconium phosphate (A1-3). The thickness of the obtained separator (S13) was 25 and the amount of α-zirconium phosphate (Z1) supported was 1.0 mg/cm².

### Comparative Example 12

An ion-trapping agent processing liquid was prepared and a separator was produced in the same manner as in Example 11 except that α-titanium phosphate (H type) synthesized in Synthesis Example 2 was used instead of wholly-Li-substituted α-zirconium phosphate (A1-3). The thickness of the obtained separator (S14) was 25 and the amount of α-titanium phosphate (H type) supported was 0.8 mg/cm².

### Comparative Example 13

An ion-trapping agent processing liquid was prepared and a separator was produced in the same manner as in Example 11 except that a fine powder (median particle size: 20 μm) obtained by grinding aluminium dihydrogen triphosphate “K-FRESH #100P” (trade name) manufactured by Tayca Corporation in a bead mill was used instead of wholly-Li-substituted α-zirconium phosphate (A1-3). The thickness of the obtained separator (S15) was 25 μm, and the amount of alumina particles supported was 1.1 mg/cm².

TABLE 2

| | | | Mass ratio | | | Ni²⁺ ion |
|---|---|---|---|---|---|---|
| | | | of ion- | Amount of | | concentration |
| | | | trapping | on-trapping | | after Ni²⁺ |
| | | | agent | agent supported | Thickness | ion trapping |
| | Separator | Ion-trapping agent | to binder | (mg/cm²) | (μm) | (ppm) |
| Example 11 | S1 | Wholly Li-substituted α-zirconium phosphate(A1-3) | 95/5 | 1.0 (one-sided | 25 | <1 |
| | | | | coating) | | |
| Example 12 | S2 | Calcined wholly Li-substituted α-zirconium phosphate | 95/5 | 1.1 (one-sided | 25 | <1 |
| | | (A1-3) | | coating) | | |
| Example 13 | S3 | 3 meq-Li-substituted α-zirconium phosphate(A1-2) | 95/5 | 1.0 (one-sided | 25 | 3 |
| | | | | coating) | | |
| Example 14 | S4 | Wholly Li-substituted α-titanium phosphate (B-3) | 95/5 | 0.8 (one-sided | 25 | <1 |
| | | | | coating) | | |
| Example 15 | S5 | 3 meq-Li-substituted α-titanium phosphate (B-2) | 95/5 | 0.8 (one-sided | 25 | 4 |
| | | | | coating) | | |
| Example 16 | S6 | Wholly Li-substituted aluminium dihydrogen | 95/5 | 1.1 (one-sided | 25 | <1 |
| | | triphosphate(C-1) | | coating) | | |
| Example 17 | S7 | Wholly Li-substituted α-zirconium phosphate(A1-3) | 95/5 | 2.0 (both-sided | 30 | 4 |
| | | | | coating) | | |
| Example 18 | S8 | Wholly Li-substituted α-zirconium phosphate(A1-3) | 95/5 | 0.5 (one-sided | 23 | 3 |
| | | | | coating) | | |
| Example 19 | S9 | Wholly Li-substituted α-zirconium phosphate(A1-3) | 95/5 | 3.0 (one-sided | 35 | <1 |
| | | | | coating) | | |
| Example 20 | S10 | Wholly Li-substituted α-zirconium phosphate(A1-3) | 85/15 | 0.9 (one-sided | 25 | 5 |
| | | | | coating) | | |
| Comparative Example 9 | S11 | None | — | — | 20 | 99 |
| Comparative Example 10 | S12 | Alumina | 95/5 | 1.6 (one-sided | 25 | 98 |
| | | | | coating) | | |
| Comparative Example 11 | S13 | α-zirconium phosphate (Z1) | 95/5 | 1.0 (one-sided | 25 | 95 |
| | | | | coating) | | |
| Comparative Example 12 | S14 | α-titanium phosphate | 95/5 | 0.8 (one-sided | 25 | 92 |
| | | | | coating) | | |
| Comparative Example 13 | S15 | Aluminium dihydrogen triphosphate | 95/5 | 1.1 (one-sided | 25 | 70 |
| | | | | coating) | | |

As is apparent from Table 2, the separators of Comparative Examples 9 to 13 were found to have insufficiently trapped Ni²⁺ ions, while on the other hand, the separators of Examples 11 to 20 were able to reduce Ni²⁺ ions to 5 ppm by mass or less.

4. Production and Evaluation of Lithium-Ion Rechargeable Battery

### Example 21

First, a positive electrode and a negative electrode were prepared. Then, a lithium-ion rechargeable battery was produced using these positive and negative electrodes, the separator obtained in Example 11 (S1), and a nonaqueous electrolyte solution manufactured by Kishida Chemical Co., Ltd.

(1) Preparation of Positive Electrode

A positive electrode-containing slurry was obtained by mixing and dispersing 90 parts by mass of Li(Ni_{1/3}Mn_{1/3}Co_{1/3})O₂ (positive electrode active material), 7 parts by mass of acetylene black (conductive agent), 3 parts by mass of polyvinylidene fluoride (binder), and 100 parts by mass of N-methyl-2-pyrrolidone (solvent).

Subsequently, the positive electrode material-containing slurry was applied to the surface of an aluminum foil having a thickness of 20 μm (positive electrode current collector) by doctor blade coating such that the thickness of the coating film was adjusted to 30 μm. The coating film was dried, thereby forming a positive electrode active material layer. Then, compression molding was conducted using a roll press, and the resulting molded produce was cut to a certain size (35 mm×70 mm), thereby obtaining a positive electrode for a lithium-ion rechargeable battery.

(2) Preparation of Negative Electrode

A negative electrode-containing slurry was obtained by mixing and dispersing 90 parts by mass of amorphous carbon (negative electrode active material), 7 parts by mass of acetylene black (conductive agent), 3 parts by mass of polyvinylidene fluoride (binder), and 100 parts by mass of N-methyl-2-pyrrolidone (solvent).

Subsequently, the negative electrode material-containing slurry was applied to the surface of a copper foil having a thickness of 20 μm (positive electrode current collector) by doctor blade coating such that the thickness of the coating film was adjusted to 30 μm. The coating film was dried, thereby forming a negative electrode active material layer. Then, compression molding was conducted using a roll press, and the resulting molded produce was cut to a certain size (35 mm×70 mm), thereby obtaining a negative electrode for a lithium-ion rechargeable battery.

(3) Production of Lithium-Ion Rechargeable Battery

The negative electrode, the 40 mm×80 mm separator (S1), and the positive electrode were layered in that order such that the ion-trapping agent-containing layer side of the separator (S1) was allowed to face the positive electrode. The layered product was housed in an aluminum packaging material (battery exterior material). Then, a nonaqueous electrolyte solution manufactured by Kishida Chemical Co., Ltd. was injected thereinto so as not to introduce air. Thereafter, in order to seal the contents, the opening of the aluminum packaging material was heat-sealed at 150° C., thereby obtaining a lithium-ion rechargeable battery (L1) wrapped with a 50 mm×80 mm×6 mm aluminum laminate exterior material. Note that the non-aqueous electrolyte solution was prepared by adding 1M-LiPF₆ as a supporting electrolyte to a solvent obtained by mixing ethylene carbonate (EC) and ethyl methyl carbonate (EMC) at a volume ratio of EC/EMC= 3/7.

Next, the lithium-ion rechargeable battery (L1) was initialized in the following manner, the initial capacity and cycle characteristics were determined, and safety testing was conducted. The results are shown in Table 3.

### (Initialization)

Starting from the state of open circuit, the lithium-ion rechargeable battery (L1) was charged at a constant current corresponding to the 3-hour rate until the battery voltage reached 4.2 V. After the battery voltage reached 4.2 V, the current value was maintained at 4.2 V until the current value reached to a level corresponding to the 0.1-hour rate. These two charging steps are referred to as “charging under standard conditions” and the state of being charged is expressed as “fully charged.”

Then, charging was discontinued and paused for 30 minutes. This step is referred to as “pause.” Subsequently, discharging at a constant current corresponding to the 3-hour rate was initiated, and discharging was continued until the battery voltage reached 3.0 V. This step is referred to as “discharging under standard conditions.” Thereafter, discharging was discontinued and “pause” was carried out.

Thereafter, a cycle of “charging under standard conditions,” “pause,” “discharging under standard conditions,” and “pause” was repeated 3 times. In addition to that, “charging under standard conditions” and “pause” were carried out, discharging at a constant current corresponding to the 3-hour rate was initiated, and discharging was continued until the battery voltage reached 3.8 V. This state is referred to as “semi-charging.” Then, one-week aging was performed to complete initialization.

Note that the term “hour rate” is defined as a current value for discharging of a designed battery capacity for a predetermined period of time. For example, the 3-hour rate means a current value for discharging of the designed battery capacity in 3 hours. Furthermore, given that the battery capacity is represented by C (unit: Ah), the current value of the 3-hour rate becomes C/3 (unit: A).

(A) Measurement of Initial Capacity

A cycle of “charging under standard conditions,” “pause,” “discharging under standard conditions,” and “pause” was repeated three times using the initialized lithium-ion rechargeable battery (L1), the discharging capacity was determined at each time, and the average value was designated as the “initial capacity.” Note that the values shown in Table 3 are obtained by standardization, provided that the average value of the discharge capacity in Comparative Example 14 using a separator (S11) containing no ion-trapping agent was determined to be “1.00.”

(B) Evaluation of Cycle Characteristics

The lithium-ion rechargeable battery (L1), for which the initial capacity was measured, was placed in a thermostat bath at 40° C. After the surface temperature of the rechargeable battery reached 40° C., this state was maintained for 12 hours. Then, a cycle of “charging under standard conditions” and “discharging under standard conditions” was repeated 200 times without providing “pause.” Thereafter, the discharging capacity of the rechargeable battery was determined in the same manner as in the case of the “initial capacity.” Note that the “post-testing capacity” shown in Table 3 indicates a value when the average value of the discharging capacity in Comparative Example 14 using a separator (S11) containing no ion-trapping agent was determined to be “1.00.” Cycle characteristics (degree of deterioration due to cycle test) were evaluated based on this “post-testing capacity.”

(C) Safety Test

The initialized lithium-ion rechargeable battery (L1) was fully charged via charging at 4.2 V and placed on a constraining plate having a 20-mm hole. Then, the constraining plate was placed in a press, on the top of which a ϕ 3-mm steel nail was mounted. By driving the press machine, nail penetration through the exterior packaging material was performed, thereby forcibly causing internal short circuit. In other words, the nail was moved at a rate of 80 mm/second until the nail penetrated through the lithium-ion rechargeable battery (L1) such that the tip of the nail reached inside of the hole of the constraining plate. The battery after withdrawing the nail was observed at room temperature under atmospheric conditions. The result of a test during which neither ignition nor explosion occurred until the lapse of one hour was judged as “passed,” which is expressed as “A” in Table 3. In addition, the result of a test during which ignition occurred within one hour is expressed as “C” in Table 3.

In the lithium-ion rechargeable battery (L1), immediately after the occurrence of short circuit due to nail penetration, the battery voltage suddenly declined. The Joule heat generated by short circuit caused the battery temperature and the battery surface temperature in the vicinity of the penetrated portion to gradually increase, and eventually increased to about 150° C. at a maximum. However, significant exotherm was not further observed, and it did not result in thermal runaway.

### Example 22

A laminated-cell-type lithium-ion rechargeable battery (L2) was obtained in the same manner as in Example 21 except that a negative electrode, a separator (S1), and a positive electrode are layered such that the ion-trapping agent-containing layer side of the separator (S1) was allowed to face the negative electrode. Then, evaluation of the initial capacity and cycle characteristics and a safety test were conducted in the same manner as in Example 21. In the safety test, the lithium-ion rechargeable battery (L2) showed behaviors similar to those of the lithium-ion rechargeable battery (L1). The above results are shown in Table 3.

### Example 23

A laminated-cell-type lithium-ion rechargeable battery (L3) was obtained in the same manner as in Example 21 except that a separator (S2) was used instead of the separator (S1). Then, evaluation of the initial capacity and cycle characteristics and a safety test were conducted in the same manner as in Example 21. In the safety test, the lithium-ion rechargeable battery (L3) showed behaviors similar to those of the lithium-ion rechargeable battery (L1). The above results are shown in Table 3.

### Example 24

A laminated-cell-type lithium-ion rechargeable battery (L4) was obtained in the same manner as in Example 21 except that a separator (S3) was used instead of the separator (S1). Then, evaluation of the initial capacity and cycle characteristics and a safety test were conducted in the same manner as in Example 21. In the safety test, the lithium-ion rechargeable battery (L 4) showed behaviors similar to those of the lithium-ion rechargeable battery (L1). The above results are shown in Table 3.

### Example 25

A laminated-cell-type lithium-ion rechargeable battery (L5) was obtained in the same manner as in Example 21 except that a separator (S4) was used instead of the separator (S1). Then, evaluation of the initial capacity and cycle characteristics and a safety test were conducted in the same manner as in Example 21. In the safety test, the lithium-ion rechargeable battery (L5) showed behaviors similar to those of the lithium-ion rechargeable battery (L1). The above results are shown in Table 3.

### Example 26

A laminated-cell-type lithium-ion rechargeable battery (L6) was obtained in the same manner as in Example 21 except that a separator (S5) was used instead of the separator (S1). Then, evaluation of the initial capacity and cycle characteristics and a safety test were conducted in the same manner as in Example 21. In the safety test, the lithium-ion rechargeable battery (L6) showed behaviors similar to those of the lithium-ion rechargeable battery (L1). The above results are shown in Table 3.

### Example 27

A laminated-cell-type lithium-ion rechargeable battery (L7) was obtained in the same manner as in Example 21 except that a separator (S6) was used instead of the separator (S1). Then, evaluation of the initial capacity and cycle characteristics and a safety test were conducted in the same manner as in Example 21. In the safety test, the lithium-ion rechargeable battery (L7) showed behaviors similar to those of the lithium-ion rechargeable battery (L1). The above results are shown in Table 3.

### Example 28

A laminated-cell-type lithium-ion rechargeable battery (L4) was obtained in the same manner as in Example 21 except that a separator (S7) having ion-trapping agent-containing layers on both sides thereof was used instead of the separator (S1). Then, evaluation of the initial capacity and cycle characteristics and a safety test were conducted in the same manner as in Example 21. In the safety test, the lithium-ion rechargeable battery (L4) showed behaviors similar to those of the lithium-ion rechargeable battery (L1). The above results are shown in Table 3.

### Example 29

A laminated-cell-type lithium-ion rechargeable battery (L9) was obtained in the same manner as in Example 21 except that a separator (S8) was used instead of the separator (S1). Then, evaluation of the initial capacity and cycle characteristics and a safety test were conducted in the same manner as in Example 21. In the safety test, the lithium-ion rechargeable battery (L9) showed behaviors similar to those of the lithium-ion rechargeable battery (L1). The above results are shown in Table 3.

### Example 30

A laminated-cell-type lithium-ion rechargeable battery (L10) was obtained in the same manner as in Example 21 except that a separator (S9) was used instead of the separator (S1). Then, evaluation of the initial capacity and cycle characteristics and a safety test were conducted in the same manner as in Example 21. In the safety test, the lithium-ion rechargeable battery (L10) showed behaviors similar to those of the lithium-ion rechargeable battery (L1). The above results are shown in Table 3.

### Example 31

A laminated-cell-type lithium-ion rechargeable battery (L11) was obtained in the same manner as in Example 21 except that a separator (S10) was used instead of the separator (S1). Then, evaluation of the initial capacity and cycle characteristics and a safety test were conducted in the same manner as in Example 21. In the safety test, the lithium-ion rechargeable battery (L11) showed behaviors similar to those of the lithium-ion rechargeable battery (L1). The above results are shown in Table 3.

### Comparative Example 14

A laminated-cell-type lithium-ion rechargeable battery (L12) was obtained in the same manner as in Example 21 except that a separator (S11) was used instead of the separator (S1). Then, evaluation of the initial capacity and cycle characteristics and a safety test were conducted in the same manner as in Example 21. The above results are shown in Table 3.

In the safety test, immediately after the occurrence of short circuit due to nail penetration, the battery voltage suddenly declined. The battery temperature and the battery surface temperature in the vicinity of the penetrated portion rapidly increased, which resulted in the thermal runaway state, and eventually increased to about 400° C. at a maximum at about 40 seconds after withdrawing the nail. Moreover, sparks were generated from the penetrated portion after thermal runaway, resulting in ejection of high-temperature smoke.

### Comparative Example 15

A laminated-cell-type lithium-ion rechargeable battery (L13) was obtained in the same manner as in Example 21 except that a separator (S12) was used instead of the separator (S1). Then, evaluation of the initial capacity and cycle characteristics and a safety test were conducted in the same manner as in Example 21. In the safety test, the lithium-ion rechargeable battery (L13) showed behaviors similar to those of the lithium-ion rechargeable battery (L1). The above results are shown in Table 3.

### Comparative Example 16

A laminated-cell-type lithium-ion rechargeable battery (L14) was obtained in the same manner as in Example 21 except that a separator (S13) was used instead of the separator (S1). Then, evaluation of the initial capacity and cycle characteristics and a safety test were conducted in the same manner as in Example 21. In the safety test, the lithium-ion rechargeable battery (L14) showed behaviors similar to those of the lithium-ion rechargeable battery (L1). The above results are shown in Table 3.

### Comparative Example 17

A laminated-cell-type lithium-ion rechargeable battery (L15) was obtained in the same manner as in Example 21 except that a separator (S14) was used instead of the separator (S1). Then, evaluation of the initial capacity and cycle characteristics and a safety test were conducted in the same manner as in Example 21. In the safety test, the lithium-ion rechargeable battery (L15) showed behaviors similar to those of the lithium-ion rechargeable battery (L1). The above results are shown in Table 3.

### Comparative Example 18

A laminated-cell-type lithium-ion rechargeable battery (L16) was obtained in the same manner as in Example 21 except that a separator (S15) was used instead of the separator (S1). Then, evaluation of the initial capacity and cycle characteristics and a safety test were conducted in the same manner as in Example 21. In the safety test, the lithium-ion rechargeable battery (L16) showed behaviors similar to those of the lithium-ion rechargeable battery (L1). The above results are shown in Table 3.

TABLE 3

| | Lithium-ion | | | | Capacity after | |
|---|---|---|---|---|---|---|
| | rechargeable | | | Initial | charging | Nail penetration |
| | battery | Separator | Side of Ion-trapping agent-containing layer | capacity | and discharging | test |
| Example 21 | L1 | S1 | Positive electrode side | 1.00 | 0.86 | A |
| Example 22 | L2 | S1 | Negative electrode side | 1.00 | 0.86 | A |
| Example 23 | L3 | S2 | Positive electrode side | 1.01 | 0.88 | A |
| Example 24 | L4 | S3 | Positive electrode side | 0.99 | 0.83 | A |
| Example 25 | L5 | S4 | Positive electrode side | 1.00 | 0.74 | A |
| Example 26 | L6 | S5 | Positive electrode side | 0.99 | 0.82 | A |
| Example 27 | L7 | S6 | Positive electrode side | 1.00 | 0.83 | A |
| Example 28 | L8 | S7 | Positive electrode side and Negative electrode side | 0.98 | 0.86 | A |
| Example 29 | L9 | S8 | Positive electrode side | 1.01 | 0.82 | A |
| Example 30 | L10 | S9 | Positive electrode side | 0.97 | 0.85 | A |
| Example 31 | L11 | S10 | Positive electrode side | 1.00 | 0.82 | A |
| Comparative Example 14 | L12 | S11 | Positive electrode side | 1.00 | 0.80 | C |
| Comparative Example 15 | L13 | S12 | Positive electrode side | 0.96 | 0.70 | A |
| Comparative Example 16 | L14 | S13 | Positive electrode side | 1.00 | 0.60 | A |
| Comparative Example 17 | L15 | S14 | Positive electrode side | 0.98 | 0.54 | A |
| Comparative Example 18 | L16 | S15 | Positive electrode side | 0.97 | 0.50 | A |

As is apparent from Table 3, a lithium-ion rechargeable battery including a separator containing a phosphate, in which at least some of ion exchange groups are substituted by lithium ions (the ion-trapping agent of the invention) is excellent in terms of cycle characteristics and safety.

### INDUSTRIAL APPLICABILITY

The ion-trapping agent of the invention can be used for a constituent member such as an electrolyte solution or a separator of a lithium-ion rechargeable battery. For example, the separator of the invention can be used for electrochemical devices such as a lithium ion capacitor (hybrid capacitor), in which a positive electrode has an electrical double layer structure and a negative electrode has a lithium-ion rechargeable battery structure, and a metal lithium rechargeable battery other than a lithium-ion rechargeable battery.

The lithium-ion rechargeable battery of the invention can be used as a paper-type battery, a button-type battery, a coin-type battery, a layered-type battery, a cylindrical battery, a prismatic battery, or the like for portable devices such as mobile phones, tablet computers, laptop computers, and gaming machines, vehicles such as electric vehicles and hybrid electric vehicles, power storage, and the like

Explanation of Reference Numerals and Symbols
10: leaded storage element, 15: porous base material, 20: separator, 30: positive electrode, 32: positive electrode current collector, 34: positive electrode active material layer, 40: negative electrode, 42: negative electrode current collector, 44: negative active material layer, 52, 54: lead, 60: ion-trapping agent

1. An ion-trapping agent for a lithium-ion rechargeable battery, which contains a phosphate in which some of ion exchange groups are substituted by lithium ions.

2. The ion-trapping agent for a lithium-ion rechargeable battery according to claim 1, wherein the phosphate is at least one selected from:
(A) α-zirconium phosphate in which at least some of ion exchange groups are substituted by lithium ions;
(B) α-titanium phosphate in which at least some of ion exchange groups are substituted by lithium ions; or
(C) aluminium dihydrogen triphosphate in which at least some of ion exchange groups are substituted by lithium ions.

3. The ion-trapping agent for a lithium-ion rechargeable battery according to claim 2, wherein the component (A) is α-zirconium phosphate in which ion exchange groups accounting for from 0.1 to 6.7 meq/g out of the total cation exchange capacity are substituted by the lithium ions.

4. The ion-trapping agent for a lithium-ion rechargeable battery according to claim 2, wherein α-zirconium phosphate before substitution by the lithium ions is a compound represented by the following Formula (1),
Zr₁₋ₓHfₓHₐ(PO₄)_{b}.nH₂O (1)
wherein a and b are positive numbers satisfying 3b−a=4, 2<b≤2.1, 0≤x≤0.2, and n is 0≤n≤2.

5. The ion-trapping agent for a lithium-ion rechargeable battery according to claim 2, wherein the component (B) is α-titanium phosphate in which ion exchange groups accounting for from 0.1 to 7.0 meq/g out of the total cation exchange capacity are substituted by the lithium ions.

6. The ion-trapping agent for a lithium-ion rechargeable battery according to claim 2, wherein α-titanium phosphate before substitution by the lithium ions is a compound represented by the following Formula (2),
TiHₛ(PO₄)ₜ.nH₂O (2)
wherein s and t are positive numbers satisfying 3t−s=4, 2<t≤2.1, and 0≤n≤2.

7. The ion-trapping agent for a lithium-ion rechargeable battery according to claim 2, wherein the component (C) is aluminium dihydrogen triphosphate in which ion exchange groups accounting for from 0.1 to 6.9 meq/g out of the total cation exchange capacity are substituted by the lithium ions.

8. The ion-trapping agent for a lithium-ion rechargeable battery according to claim 2, wherein aluminium dihydrogen triphosphate before substitution by the lithium ions is a compound represented by the following Formula (3),
AlH₂P₃O₁₀.nH₂O (3)
wherein n is a positive number.

9. The ion-trapping agent for a lithium-ion rechargeable battery according to claim 1, wherein the water content is 10% by mass or less.

10. An electrolyte solution, which contains the ion-trapping agent for a lithium-ion rechargeable battery according to claim 1.

11. A separator, which contains the ion-trapping agent for a lithium-ion rechargeable battery according to claim 1.

12. A lithium-ion rechargeable battery, which includes a positive electrode, a negative electrode, an electrolyte solution, and a separator, wherein at least one of the positive electrode, the negative electrode, the electrolyte solution, or the separator contains the ion-trapping agent for a lithium-ion rechargeable battery according to claim 1.
